(19) United States
(12) Patent Application Publication
(10) Pub. No.: US 2021/0165251 A1
(43) Pub. Date: Jun. 3, 2021

(54) METHOD AND SYSTEM FOR CONTROLLING A VARIABLE TRANSMITTANCE OPTICAL FILTER IN RESPONSE TO AT LEAST ONE OF TEMPERATURE, COLOR, AND CURRENT

(71) Applicant: SWITCH MATERIALS INC., Burnaby (CA)

(72) Inventors: Matthew P. Smit, Burnaby (CA); Ryan J. Gibson, Burnaby (CA)

(21) Appl. No.: 16/641,179

(22) PCT Filed: Aug. 24, 2018
(86) PCT No.: PCT/CA2018/051026

§ 371 Date: Feb. 21, 2020

Related U.S. Application Data
(60) Provisional application No. 62/550,526, filed on Aug. 25, 2017.

(51) Int. Cl. G02F 1/01; G02F 1/23; B32B 17/10

(52) U.S. Cl. CPC G02F 1/0121; G02F 1/23; B32B 17/10779; B32B 17/10211; B32B 2551/00; B32B 17/10761; G02F 2203/055; G02F 2201/58; G02F 2203/11; B32B 17/10486

(57) ABSTRACT

Methods, systems, and techniques for controlling a variable transmittance optical filter involve determining at least one of a temperature of, color of, and current flowing through the optical filter, and adjusting the voltage applied across the filter in response to at least one of the temperature, color, and current. The transmittance of the optical filter decreases until reaching a minimum on exposure to a first stimulus and increases until reaching a maximum in response to application of a second stimulus, and at least one of the first and second stimuli involves applying a voltage across the filter.

### TECHNICAL FIELD

The present disclosure is directed at methods, systems, and techniques for controlling a variable transmittance optical filter in response to at least one of temperature, color, and current.

### BACKGROUND

A variable transmittance optical filter refers to an optical filter that has a transmittance that varies in response to stimuli. For example, the transmittance of the filter may increase in response to a first stimulus, such as voltage, and decrease in response to a second stimulus, such as visible light. A control system may be used to control the filter's transmittance.

### SUMMARY

According to a first aspect, there is provided a method for controlling a variable transmittance optical filter, the method comprising determining at least one of a temperature of, color of, and current flowing through the optical filter, wherein transmittance of the optical filter decreases until reaching a minimum on exposure to a first stimulus and increases until reaching a maximum in response to application of a second stimulus, wherein at least one of the first and second stimuli comprises applying a voltage across the filter; and in response to at least one of the temperature, color, and current, adjusting the voltage applied across the filter. In at least some other aspects, the voltage applied to the optical filter may also be determined.

The temperature of the optical filter may be determined, and the voltage may be applied across the filter is adjusted in response to the temperature.

Determining the magnitude of the voltage may comprise comparing the temperature to a shutdown temperature; and when the temperature equals or exceeds the shutdown temperature, short circuiting or open circuiting the filter.

Adjusting the voltage applied across the filter may comprise determining a magnitude of the voltage that corresponds to the temperature; and applying the voltage across the filter, wherein the magnitude of the voltage that is applied is the magnitude that corresponds to the temperature.

The magnitude that corresponds to the temperature may be a minimum magnitude required for the entirety of the filter to be at a threshold transmittance.

The threshold transmittance may be the maximum transmittance of the filter.

Determining the magnitude of the voltage may comprise referring to a one-to-one mapping of magnitudes and temperatures, wherein the magnitudes of the mapping increase monotonically between a first temperature of the mapping and a second temperature of the mapping that is higher than the first temperature.

The first and second temperatures may span at least 45° C.

The first and second temperatures may span from at least −40° C. to 125° C.

The magnitudes of the mapping decrease may monotonically between a third temperature of the mapping and a fourth temperature of the mapping, wherein the fourth temperature is higher than the third temperature and less than the first temperature.

The third temperature may be less than 25° C.

The optical filter may comprises a switching material attached to a non-opaque substrate, and determining the temperature may comprise measuring a temperature of the substrate; and from the temperature of the substrate, determining the temperature of the optical filter as the temperature of the switching material.

The optical filter may comprise a switching material located between two non-opaque substrates, and determining the temperature may comprise measuring an ambient temperature of the optical filter; measuring intensity of a wavelength of light incident on the optical filter; and from the ambient temperature of and the intensity of light incident on the optical filter, determining the temperature of the optical filter as the temperature of the switching material.

The color of the optical filter may be determined, and the voltage applied across the filter is adjusted in response to the color.

The color of the filter may vary as the filter transitions between the light and dark states, and the method may further comprise determining an initial indication of intensity of a first wavelength of light transmitted through the filter, wherein adjusting the voltage applied across the filter adjusts the initial indication of intensity; comparing the initial indication of intensity to a first wavelength threshold; and adjusting the voltage applied across the filter in response to how the initial indication of intensity compares to the first wavelength threshold.

The voltage applied across the filter may be adjusted in response to whether the initial indication of intensity equals or exceeds the first wavelength threshold.

The initial indication of intensity may comprise a first wavelength ratio corresponding to a first time, and the method may further comprise determining the first wavelength ratio by determining a ratio of intensity of the first wavelength of light incident on the filter at the first time relative to intensity of the first wavelength of light transmitted through the filter at the first time.

The first wavelength may be red having a wavelength centered at approximately 615 nm.

The method may further comprise determining a second wavelength ratio corresponding to the first time by determining a ratio of intensity of a second wavelength of light incident on the filter at the first time relative to intensity of the second wavelength of light transmitted through the filter at the first time, wherein the first and second wavelengths are different, and wherein the first wavelength ratio varies with the second wavelength ratio.

The second wavelength may be green having a wavelength centered at approximately 525 nm.

The method may further comprise determining a subsequent indication of intensity by determining the first wavelength ratio corresponding to a second time by determining a ratio of intensity of the first wavelength of light incident on the filter at the second time relative to intensity of the first wavelength of light transmitted through the filter at the second time, wherein the second time is after the first time; and determining the second wavelength ratio corresponding to the second time by determining a ratio of intensity of the second wavelength of light incident on the filter at the second time relative to intensity of the second wavelength of light transmitted through the filter at the second time; comparing the subsequent indication of intensity to the first wavelength threshold and to the initial indication of intensity; and adjusting the voltage applied across the filter in response to how the initial and subsequent indications of intensity compare to the first wavelength threshold and to each other.

Adjusting the voltage applied across the filter in response to how the initial and subsequent indications of intensity compare to the first wavelength threshold and to each other may comprise any one or more of the following:
(a) when the initial and subsequent indications of intensity are less than the first wavelength threshold by an error threshold and the subsequent indication of intensity is less than the initial indication of intensity, decreasing the voltage applied across the filter by a first voltage step;
(b) when the initial and subsequent indications of intensity are less than the first wavelength threshold by an error threshold and equal to each other, decreasing the voltage applied across the filter by a second voltage step that is less than the first voltage step;
(c) when the initial and subsequent indications of intensity are less than the first wavelength threshold by an error threshold and the subsequent indication of intensity is greater than the initial indication of intensity, increasing the voltage applied across the filter by the second voltage step;
(d) when the initial and subsequent indications of intensity are greater than the first wavelength threshold by an error threshold and equal to each other, increasing the voltage applied across the filter by the second voltage step;
(e) when the initial and subsequent indications of intensity are greater than the first wavelength threshold by an error threshold and the subsequent indication of intensity is greater than the initial indication of intensity, increasing the voltage applied across the filter by the first voltage step; and
(f) when the initial indication of intensity is greater than the first wavelength threshold and the subsequent indication of intensity is less than the first wavelength threshold by an error threshold and less than the initial indication of intensity, decreasing the voltage applied across the filter by the second voltage step.

Adjusting the voltage across the filter may comprise short circuiting or open circuiting the filter.

The initial indication of intensity may comprise a first and a second wavelength ratio each corresponding to a first time, and the method may further comprise determining the first wavelength ratio by determining a ratio of intensity of the first wavelength of light incident on the filter at the first time relative to intensity of the first wavelength of light transmitted through the filter at the first time; and determining the second wavelength ratio by determining a ratio of intensity of a second wavelength of light incident on the filter at the first time relative to intensity of the second wavelength of light transmitted through the filter at the first time, wherein the first and second wavelengths are different, wherein the first wavelength threshold and a second wavelength threshold define a desirable color space, wherein comparing the initial indication of intensity to the first wavelength threshold comprises determining whether the initial indication of intensity is in the desirable color space, and wherein adjusting the voltage across the filter comprises short circuiting or open circuiting the filter when the initial indication of intensity is in the desirable color space.

The first wavelength may be blue, having a wavelength centered at approximately 465 nm, and the second wavelength may be green, having a wavelength centered at approximately 525 nm.

Determining the color of the optical filter may comprise using a color sensing device, the sensing device comprising a color sensor; and one or more filters collectively filtering near-infrared and far-infrared wavelengths, wherein the one or more filters are positioned such that light incident on the color sensor passes through the one or more filters before being incident on the color sensor and wherein the near-infrared wavelengths are between approximately 700 nm and 1,000 nm and the far-infrared wavelengths are above approximately 1,000 nm and, in certain aspects, less than or equal to approximately 2,500 nm.

The one or more filters may comprise a near-infrared filter and a far-infrared filter.

The current flowing through the optical filter may be determined, and the voltage applied across the filter may be adjusted in response to the current.

The method may further comprise determining, from the current flowing through the filter, a voltage magnitude sufficient to cause an entirety of the optical filter to exceed a minimum transmittance; and applying the voltage having the voltage magnitude across the filter.

The method may further comprise increasing the voltage applied across the filter to a minimum voltage required to cause an entirety of the filter to exceed a minimum transmittance by iteratively determining, from the current flowing through the filter, the minimum voltage required to cause an entirety of the filter to exceed the minimum transmittance; comparing the voltage applied across the filter to the minimum voltage; and when the voltage applied across the filter is less than the minimum voltage, increasing the voltage to at least the minimum voltage.

The minimum transmittance may be within 10% of the transmittance of the optical filter in the light state.

The minimum transmittance may be the transmittance of the optical filter in the light state.

At least two of the temperature of, color of, and current flowing through the optical filter may be determined, and the voltage applied across the filter may be adjusted in response to the at least two of the temperature of, color of, and current flowing through the optical filter that are determined.

All of the temperature of, color of, and current flowing through the optical filter are determined, and the voltage applied across the filter may be adjusted in response to all of the temperature of, color of, and current flowing through the optical filter that are determined.

The current may be used to determine the voltage applied across the filter and the temperature may be used to define a desirable color space.

The first stimulus may comprise incident visible light and the second stimulus comprises applying the voltage.

The filter may comprise a non-opaque substrate; a switching material affixed to the substrate and positioned such that at least some light that passes through the substrate also passes through the switching material; and a first electrode and a second electrode electrically coupled to the switching material, wherein the voltage is applied across the first and second electrodes.

Each of the first and second electrodes may be a planar electrode, and the filter may further comprise a first and a second bus bar respectively electrically coupled to the first and the second electrode, wherein the first and the second bus bar are positioned such that all current paths between the bus bars have identical path lengths.

According to another aspect, there is provided a variable transmittance optical filter assembly, the assembly comprising a non-opaque substrate; a switching material affixed to the substrate and positioned such that at least some light that passes through the substrate also passes through the switching material; a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes; voltage application circuitry for selectively applying different voltages across the electrodes; at least one of a color sensing device positioned to measure a color of light that has passed through the optical filter, a temperature sensor positioned to measure a temperature of the optical filter or an ambient temperature around the optical filter, and a current sensor electrically coupled to the voltage application circuitry; a computer readable medium and a processor communicatively coupled to the computer readable medium, the voltage application circuitry, and the at least one of the color sensor, temperature sensor, and current sensor, wherein the computer readable medium has encoded thereon computer program code, executable by the processor, which when executed by the processor causes the processor to perform the method of any of the foregoing aspects or suitable combinations thereof.

The electrodes may be planar and the switching material may be between the electrodes.

The filter assembly may further comprise a bus-bar electrically coupled to and extending along each of the electrodes.

The bus-bars may extend along opposing edge portions of the electrodes.

The filter assembly may further comprise the color sensing device.

The color sensing device may comprise a color sensor; and one or more filters collectively filtering near-infrared and far-infrared wavelengths, wherein the one or more filters are positioned such that light incident on the color sensor passes through the one or more filters before being incident on the color sensor and wherein the near-infrared wavelengths are between approximately 700 nm and 1,000 nm and the far-infrared wavelengths are above approximately 1,000 nm and, in certain aspects, less than approximately 2,500 nm.

The one or more filters may comprise a near-infrared filter and a far-infrared filter.

The filter assembly may comprise the temperature sensor.

The filter assembly may comprise the current sensor.

According to another aspect, there is provided a method for controlling a variable transmittance optical filter, the method comprising: determining a voltage applied across the optical filter; comparing the voltage applied across the optical filter to a desired voltage; and when the voltage applied across the optical filter is less than the desired voltage, increasing the voltage applied across the optical filter until the voltage applied across the optical filter at least equals the desired voltage.

The voltage applied across the optical filter may be transmitted to the optical filter from voltage application circuitry by first and second voltage application wires, and determining the voltage applied across the optical filter may comprise measuring the voltage applied across the optical filter at a location nearer to the optical filter than to the voltage application circuitry.

At least one of the voltage application wires may comprise a contact resistance portion, and the voltage application circuitry may be connected to the at least one of the voltage application wires on one side of the contact resistance portion and the voltage applied across the optical filter may be measured on another side of the contact resistance portion.

The voltage applied across the optical filter may be measured at the optical filter.

The first voltage application wire may connect a first input terminal of the optical filter to a first terminal of the voltage application circuitry, and comparing the voltage applied across the optical filter to a desired voltage may comprise: measuring a voltage applied at the first input terminal; and determining a voltage drop across the voltage application wires from a measurement of the voltage applied at the first input terminal. Increasing the voltage may comprise increasing the voltage to compensate for the voltage drop.

The first voltage application wire may connect a first input terminal of the optical filter to a first terminal of the voltage application circuitry and the second voltage application wire may connect a second input terminal of the optical filter to a second terminal of the voltage application circuitry, and comparing the voltage applied across the optical filter to a desired voltage may comprise: measuring a voltage applied at the first input terminal; measuring a voltage applied at the second input terminal; and determining a voltage drop across the voltage application wires from measurements of the voltages applied at the first and second input terminals. Increasing the voltage may comprise increasing the voltage to compensate for the voltage drop.

According to another aspect, there is provided a variable transmittance optical filter assembly, the assembly comprising: a non-opaque substrate; a switching material affixed to the substrate and positioned such that at least some light that passes through the substrate also passes through the switching material; a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes; voltage application circuitry for selectively applying different voltages across the electrodes; a voltage sensor electrically coupled to the optical filter to measure the voltage applied across the optical filter; and a computer readable medium and a processor communicatively coupled to the computer readable medium, the voltage application circuitry, and the voltage sensor, wherein the computer readable medium has encoded thereon computer program code, executable by the processor, which when executed by the processor causes the processor to perform any of the foregoing aspects of the method or suitable combinations thereof.

According to another aspect, there is provided a non-transitory computer readable medium having encoded thereon computer program code, executable by a processor, which when executed by the processor causes the processor to perform the method of any of the foregoing aspects or suitable combinations thereof

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a block diagram of one embodiment of a variable transmittance filter assembly.

FIG. 2 is a graph of a first wavelength ratio vs. a second wavelength ratio for a variable transmittance optical filter, in which the first wavelength is red and the second wavelength is green, according to another embodiment.

FIG. 3 is a graph of a first wavelength ratio vs. a second wavelength ratio for a variable transmittance optical filter, in which the first wavelength is blue and the second wavelength is green, according to another embodiment.

FIG. 4 is a graph of a first wavelength ratio vs. a second wavelength ratio for a variable transmittance optical filter, in which the first wavelength is blue and the second wavelength is green and in which a desirable color state is highlighted, according to another embodiment.

FIG. 5A is an electrical schematic of a model of a variable transmittance optical filter, and FIG. 5B is a sectional view of the variable transmittance optical filter modeled in FIG. 5A, according to another embodiment.

FIGS. 6, 7A, and 7B are graphs of voltage applied to a variable transmittance optical filter relative to distance from the filter's edge, according to another embodiment.

FIG. 8 is a top plan view of a variable transmittance optical filter exhibiting “voltage droop”, according to another embodiment.

FIG. 9 is a top plan view of a variable transmittance optical filter exhibiting uniform transmittance, according to another embodiment.

FIG. 10 is a graph showing light transmitted by an infrared filter that blocks far-infrared light (PRIOR ART).

FIG. 11 is a graph showing light transmitted by an infrared filter that blocks near-infrared light (PRIOR ART).

FIGS. 12 to 14 are graphs showing calculated vs. measured transmission ratios of a red, green, and blue (“RGB”) color sensor operating in various ambient conditions and comprising one or more sensors to block near-infrared and far-infrared light, according to another embodiment.

FIG. 15 is an electrical schematic of a model of a variable transmittance optical filter with a voltage sensor electrically coupled to voltage application circuitry using two voltage sensor wires, according to another embodiment.

FIG. 16 is an electrical schematic of a model of a variable transmittance optical filter with a voltage sensor electrically coupled to voltage application circuitry using a single voltage sensor wire, according to another embodiment.

### DETAILED DESCRIPTION

A variable transmittance optical filter in the embodiments described herein has a transmittance that decreases until reaching a minimum on exposure to a first stimulus and that increases until reaching a maximum in response to application of a second stimulus. At least one of the first and second stimuli comprises applying a voltage across the filter. In the depicted embodiments, the first stimulus is light incident on a switching material comprising part of the filter, and the second stimulus is a voltage applied across the filter.

In the depicted embodiments, the optical filter further comprises a non-opaque substrate to which a switching material is affixed and positioned such that at least some light that passes through the substrate also passes through the switching material. The filter further comprises a first non-opaque and planar electrode and a second non-opaque and planar electrode between which the switching material is positioned and electrically coupled to the switching material. Voltage application circuitry is used to selectively apply different voltages across the electrodes and, consequently, across the switching material. Applying a voltage across the switching material is hereinafter interchangeably referred to as applying a voltage across the filter. Typically, the filter also comprises bus bars extending along opposing edge portions of the electrodes.

This arrangement results in a problem called “voltage droop”, in which different portions of the switching material are exposed to different voltage differences and consequently may not be at identical transmittances (in terms of one or both of intensity and color of transmitted light). The amount of voltage droop can be affected by the amount of current flowing through the device because of parasitic resistances, such as the resistances of the electrodes. Voltage droop can be addressed by increasing the voltage applied across the filter, although applying excessive voltage may decrease filter life and, in mobile applications, battery life.

For certain formulations of the switching material, the required applied voltage to cause a change in transmittance may also change over time. Consequently, calibration done at the beginning of a filter's life may not be accurate near the end of the filter's life. The temperature of the filter (and more particularly, the switching material) can also affect the voltage required to fade the filter.

The embodiments described herein address one or more of these problems by determining at least one of a temperature of, color of, voltage applied to, and current flowing through the optical filter; and, in response to at least one of the temperature, color, voltage, and current, adjusting the voltage applied across the filter.

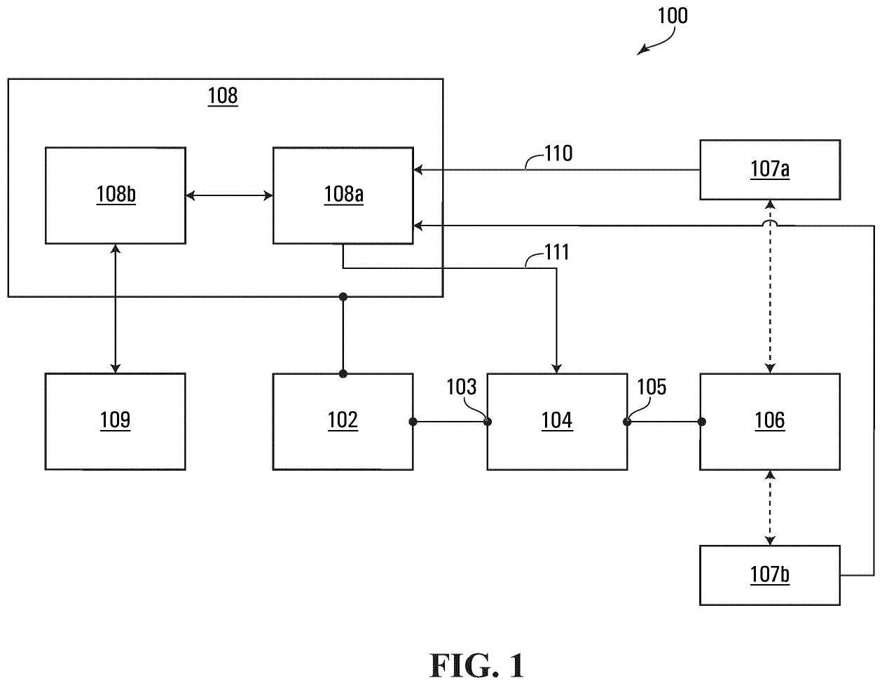

Referring to FIG. 1, there is shown one embodiment of a variable transmittance filter assembly 100. The filter assembly 100 comprises a controller 108 that comprises a processor 108b and an input/output module 108a (“I/O module”) that are communicatively coupled to each other. The controller 108 is electrically coupled to a power supply 102; a non-transitory computer readable medium 109 that has encoded on it program code that is executable by the controller 108; switching circuitry 104 controlled by the controller 108 via a control input 111, and which is also coupled to the power supply 102 through input voltage terminals 103 and which outputs a voltage from the power supply 102 across load terminals 105; an optical filter 106 across which the load terminals 105 can apply the voltage from the power supply 102; and an interior light sensor 107a and an exterior light sensor 107b (collectively, the light sensors 107a,b are referred to as the “sensors 107”). The switching circuitry 104 may comprise, for example, an H-bridge capable of applying a forward and reverse voltage across load terminals 105, as well as open and short circuiting the load terminals 105. Alternatively the switching circuitry 104 may comprise switches or relays, such as semiconductor switches, arranged in a different configuration. The switching circuitry is one example of voltage application circuitry that is for selectively applying different voltages across the electrodes. While not depicted in FIG. 1, in certain embodiments herein the light sensors 107a,b may be supplemented by or replaced with one or both of a temperature sensor (e.g., that may be affixed to the filter 106 or positioned to measure the ambient temperature of the filter 106) and a current sensor (e.g., a shunt resistor placed electrically in series with the filter 106) to permit the controller 108 to determine the temperature of and current flowing through the filter 106, respectively.

The filter 106 comprises a non-opaque substrate, such as glass used in automotive windows or polymer film; a switching material affixed to the substrate and positioned such that at least some light that passes through the substrate also passes through the switching material; and a first electrode located on one side of and electrically coupled to the switching material and a second electrode located on another side of and electrically coupled to the switching material. As mentioned above, in certain embodiments the electrodes are planar electrodes between which the switching material is located. The transmittance of the switching material decreases until reaching a minimum on exposure to sunlight and absent application across the electrodes of a voltage required to increase the transmittance, and the transmittance of the switching material increases until reaching a maximum in response to application of the voltage across the electrodes. While in the depicted example embodiment the electrodes are on opposing sides of the switching material, in different embodiments (not depicted) the electrodes may be in contact with the same side of the switching material and located on the same side of the substrate. Additionally, in different embodiments the transmittance of the switching material may change in response to different stimuli. For example, the transmittance of the switching material decreases until reaching a minimum on exposure to a first stimulus and increases until reaching a maximum in response to application of a second stimulus, wherein at least one of the first and second stimuli comprises applying a voltage across the electrodes.

A polyethylene terephthalate (“PET”) film with an electrode on it is coated with the switching material. The switching material is then covered with a second PET film with the second electrode, and the switching material, PET films, and electrodes are laminated between glass using polyvinyl butyral (“PVB”). In this embodiment, the PET film on which the switching material is coated comprises the substrate. In some different embodiments, the switching material is applied directly to the glass and a single PET film is laminated over the switching material; in additional embodiments, the switching material is laminated to the PET film and neither is affixed directly to glass. In a different embodiment, the switching material is applied directly to the a substrate such as glass and then a second substrate, such as a second pane of glace, is laminated on to the switching material without the PET film. This is one example of placing the switching material between two non-opaque substrates.

The switching material may incorporate photochromic, electrochromic, hybrid photochromic/electrochromic, liquid crystal, or suspended particle technologies. Photochromic optical filters tend to automatically darken when exposed to sunlight, and lighten in the absence of sunlight. Electrochromic, liquid crystal, and suspended particle technologies however, tend to alternate between dark and light transmissive states in response to electricity. Electrochromic optical filters, for example, tend to darken when a voltage is applied across a pair of terminals electrically coupled to different sides of the electrochromic material, and tend to lighten when the polarity of the voltage is reversed. While in the depicted embodiment the photochromic filters are tuned to darken when exposed to sunlight, in different embodiments the photochromic filters may comprise different chromophores tuned to respond to different wavelengths. For example, some chromophores may be tuned to darken in response to non-visible light, or to only a subset of wavelengths that comprise sunlight.

The optical filters 106 used in the embodiments discussed herein are based on a hybrid photochromic/electrochromic technology, which conversely darken in response to sunlight, ultraviolet, or certain other wavelengths of electromagnetic radiation (“light”) and lighten or become transparent (“fading”) in response to a non-zero voltage applied across the terminals of the optical filter assembly. Hybrid photochromic/electrochromic optical filters comprise a switching material having one or more chromophores that are reversibly convertible between colored (dark) and uncolored (faded) states; the switching material may further comprise a solvent portion, polymers, salts, or other components to support the conversion of the chromophore between colored and uncolored states when exposed to light or voltage. Some examples of chromophores comprise fulgides, diarylethenes or dithienylcyclopentenes. However, in different embodiments (not depicted), other types of optical filters comprising alternative switching materials with similar behavior to hybrid photochromic/electrochromic switching materials, may also be employed.

While the present disclosure references operative states of the assembly 106 as simply “dark”, “faded”, or “intermediate”, the optical transmittance or clarity of the filter 106 in particular states may also vary according to specific embodiments. For example, the “dark” state in one embodiment may refer to a transmittance of approximately 5%, whereas in another embodiment the “dark” state may refer to transmittance anywhere in the range of 0% to approximately 15%. In another example, the assembly 106 may be optically clear when in the “faded” state in one embodiment and only partially transparent in another embodiment.

The assembly 100 of FIG. 1 is operable to apply a portion of the supply voltage received at the input voltage terminals 103 across the load terminals 105 to transition the assembly 106 to a faded state, and is also capable of transitioning the assembly 106 to a dark state by open or short circuiting the load terminals 105. The amount of voltage applied may be based on feedback received from the light sensors 107. As described in more detail below, the sensors 107 output a signal 110 indicative of one or both of cumulative light intensity and intensity at each of one or more wavelengths of light, and send the signal 110 to the I/O module 108a of the controller 108. Additionally or alternatively, the controller 108 may determine what voltage to apply across the filter 106 based on feedback from one or both of a temperature, a voltage sensor, and a current sensor, as mentioned above. In at least some example embodiments, an example voltage sensor comprises a voltmeter or multimeter, while an example current sensor comprises an ammeter or multimeter.

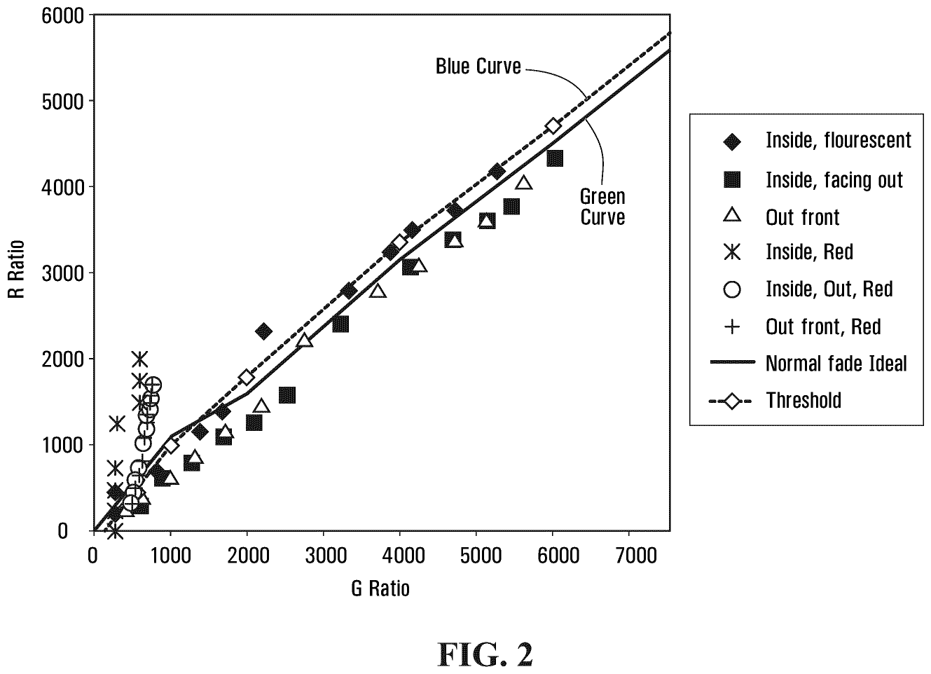

The processor 108b, through the I/O module 108a, receives and processes the signal 110 and controls the switching circuitry 104 via the control input 111 to place the assembly 106 into a desired state, as described in further detail below in respect of FIGS. 2 to 14.

If the processor 108b determines that the assembly 106 should be in the faded state, the processor 108b, via the I/O module 108a, configures the switching circuitry 104 such that at least a portion of the voltage received from the input voltage terminals 103, sufficient to transition the filter to the faded state (a “threshold voltage”), is applied across its load terminals 105 to thereby fade the filter 106. The magnitude of the threshold voltage to fade or transition the filter 106 varies according to the particular switching material used, and according to one or more of temperature of, age of, and current flowing through the switching material. In a particular embodiment, the threshold voltage is in the range of 0.6 to 2.5 V, but may also range from 0.1 to 10 V in other embodiments.

### Temperature Voltage Compensation

In certain embodiments, the temperature of the filter 106 is determined and the voltage applied across the filter 106 is adjusted in response to the temperature. As the temperature of the switching material increases, for example in photochromic/electrochromic systems, the voltage required to fade the material also increases. The most likely reason for this is that the rate of diffusion and the rate of chemical interactions increase with increased temperature. The temperature increase thus effectively lowers the resistance of the switching material, and consequently the filter 106, and increases the amount of current being drawn by the filter 106 at a given voltage. As a result of the increased current draw the amount of voltage droop across the filter 106, as a result of the resistance of the transparent conductive electrodes, increases. In order to ensure that the center of the filter 106 still fades, the voltage applied at the edges of the filter 106 to the bus-bars is increased such that the voltage at the center of the filter 106 still meets the necessary potential to fade the filter 106 based on a current-voltage scan of the filter 106 at that temperature. In certain embodiments, as the temperature decreases below room temperature (approximately 25° C.), the voltage applied across the filter 106 is decreased, kept at the same voltage as for room temperature, or actually increased. In certain embodiments, voltage is ceased to be applied across the filter 106 when the temperature of the filter 106 equals or exceeds a shutdown temperature to prevent rapid device degradation. Above a shutdown temperature of 70° C. for example, the voltage may no longer be applied across the filter 106 until the temperature of the filter 106 falls below 70° C.

In order to correctly adjust the voltage based on filter temperature, a temperature sensor is attached to the non-opaque substrate (e.g., window glass) or embedded within the filter 106 and is used by the controller 108 to monitor the temperature of the filter 106. In the case of the temperature sensor being attached to the outside of the filter 106, in one embodiment a correction factor for the temperature of the switching material based on the substrate temperature is used to determine the filter temperature from the substrate temperature. In certain other embodiments, one or more of ambient temperature sensors, light sensors, and other temperature sensors already installed within a vehicle (in embodiments in which the filter 106 comprises part of a vehicle window or sunroof) to estimate the filter's 106 temperature. Based on inbound light and ambient temperature, the controller 108 determines the filter's 106 temperature from a lookup table that indicates what the filter's 106 temperature is in those environmental conditions. One or more wavelengths of the inbound light, which may include infrared wavelengths, may be measured and used in conjunction with ambient temperature to determine filter temperature.

The temperature sensor may be any one of several types depending on location and accuracy required. For example, in one embodiment the temperature sensor comprises a thermocouple of type K, J, T, E, N, S, or R. In a different embodiment, it comprises a thermistor with a resistance of 10 kΩ. In another embodiment, it comprises a thermostat when acting as a thermal cut-off sensor. In another embodiment, the sensor comprises a resistance sensor (RTD).

In order for the controller 108 to adjust the temperature, in one embodiment it determines temperature by measuring either the current or voltage from the temperature sensor. It then determines a magnitude of the voltage that corresponds to the temperature, and applies the voltage across the filter 108, with the magnitude of the voltage that is applied being the magnitude the controller determines corresponds to the temperature. The controller 108 may determine which voltage magnitude corresponds to the temperature based on a lookup table or transfer function between filter temperature and output sensor output voltage. In one embodiment, the magnitude that corresponds to the temperature is a minimum magnitude required for the entirety of the filter to be at a threshold transmittance, which may be the transmittance of the filter.

Using a transfer function or lookup table is an example of referring to a one-to-one mapping of magnitudes and temperatures to determine voltage magnitude. The magnitudes of the mapping may increase monotonically between a first temperature of the mapping and a second temperature of the mapping that is higher than the first temperature. The first and second temperatures may span at least 45° C.; in one example, they span from at least −40° C. to 125° C. Additionally or alternatively, the magnitudes of the mapping may decrease monotonically between a third temperature of the mapping and a fourth temperature of the mapping, with the fourth temperature being higher than the third temperature and less than the first temperature. The third temperature in certain embodiments is less than room temperature (approximately 25° C.).

The controller 108 can adjust the voltage regulator supplying voltage to the device such that the output voltage matches that calculated from the lookup table or transfer function. While fading, this voltage can be further adjusted up or down based on whether the temperature of the part changes while fading.

### Voltage Compensation

In certain embodiments the color of the optical filter 106 is determined, and the voltage applied across the filter is adjusted in response to the color.

As the filter 106 undergoes weathering the potential required to fade the filter 106 also increases in certain embodiments. If the applied voltage is not increased accordingly in these embodiments the filter 106 exhibits slower kinetics, red-hangup (in which at least part of the filter 106 turns red instead of clear), or ceases fading altogether. As this change in required voltage to properly fade the filter 106 is not due to temperature, another sensor system in these embodiments is used to determine when to increase the applied voltage. It was determined through experiment that color sensors are a good candidate to measure this voltage shift as the filter 106 fades through a different color space as a result of the voltage not being high enough to fade both chromophores correctly. FIG. 2 is a graph of a first wavelength ratio vs. a second wavelength ratio for the variable transmittance optical filter 106, in which the first wavelength is red and the second wavelength is green. The graph of FIG. 2 represents data from several normal and red-hangup (under-voltage) fades. It is used to determine the normal voltage operating limits for a filter 106 (label D18237) comprising a switching material that comprises particular chromophores.

In FIG. 2 the green line represents the first wavelength ratio (an average red ratio determined by taking the red [light centered at approximately 615 nm] reading from the inside sensor, which measures light transmitted through the filter, divided by the outside sensor, which measures light incident on the filter) versus the second wavelength ratio (an average green [light centered at approximately 525 nm] ratio determined by taking the green reading from the inside sensor divided by the outside sensor) of a S164/S158 device. The blue line is the ‘threshold’ curve that is the curve above which the filter color is determined to be red and requires a voltage increase; that is, the blue line indicates the first wavelength threshold at various second wavelength ratios. Table 1 shows the results of a method the controller 108 performs in one embodiment to adjust voltage up or down depending on the severity of the red-hangup.

The method the controller 108 performs to generate the results of Table 1 comprises determining an initial and a subsequent indication of intensity of the first wavelength of light transmitted through the filter 106. To determine the initial indication of intensity, the controller 108 determines the red and green ratios at a first (initial) time, and the initial indication of intensity is the red ratio at the determined green ratio at the first time, with the red ratio varying with the green ratio as evidenced in FIG. 2. To determine the subsequent indication of intensity, the controller 108 determines the red and green ratios at a second time that is after to the first time, and the subsequent indication of intensity is the red ratio at the determined green ratio at the second time.

The controller 108 compares each of the initial and subsequent indications of intensity to the first wavelength threshold and to each other. In FIG. 2, the first wavelength threshold at the first time is the red ratio for the green ratio at the first time, which is a point on the blue curve. Similarly, the first wavelength ratio at the second time is the red ratio for the green ratio at the second time, which is also a point on the blue curve.

The controller 108 then adjusts the voltage applied across the filter in response to how the initial and subsequent indications of intensity compare to the first wavelength ratio and to each other, as indicated in Table 1 below.

In Table 1, E0 is the difference between the measured R ratio at a given initial time and the threshold R ratio for the measured G ratio at that same time (i.e., the difference between the initial indication of intensity and the first wavelength threshold at the first time). E1 represents error at the current (subsequent) time (i.e., the difference between the subsequent indication of intensity and the first wavelength threshold at the second time), E0 the error at the previous (initial) time, and T the threshold error (i.e., the maximum permitted difference between the E0/E1 and the first wavelength threshold at the first time [for E1] or the second time [for E2]) that represents the maximum the measured R ratio can be above the threshold R ratio for the measured G ratio before the measured R ratio enters the red-hangup zone.

TABLE 1

| E0 | E1 | E1 < E0 | E1 = E0 | E1 > E0 |
|---|---|---|---|---|
| <T | <T | Decrease 0.1 V | Decrease 0.05 V | Increase 0.05 V |
| <T | >T | | | Same |
| >T | >T | Same | Increase 0.05 V | Increase 0.1 V |
| >T | <T | Decrease 0.05 V | | |

In Table 1, 0.1 V represents a first voltage step and 0.05 V represents a second voltage step. In different embodiments (not depicted), different adjustments or voltage steps may be used depending on how the error values compare to each other and to the error threshold. For example, a single voltage step may be used for all situations in Table 1, or more than two voltage steps may be used. Analogously, the voltage steps may have values different than 0.1 V and 0.05 V.

In different embodiments (not depicted), the controller 108 adjusts the voltage applied across the filter in response to one of the initial and subsequent indications of intensity, and does not use both indications to determine how to adjust the voltage. For example, in one embodiment the controller 108 determines whether the initial indication of intensity equals or exceeds the first wavelength threshold, and adjusts the voltage accordingly.

The threshold error T in Table 1 may be selected to be zero or higher.

While in the depicted embodiment the indications of intensity are color ratios of identical wavelengths, in different embodiments (not depicted) they may be a different metric. For example, absolute intensity of one or more wavelengths may be used, and ratios of one or more different wavelengths may be used.

### Desirable Color or Transmittance Detection

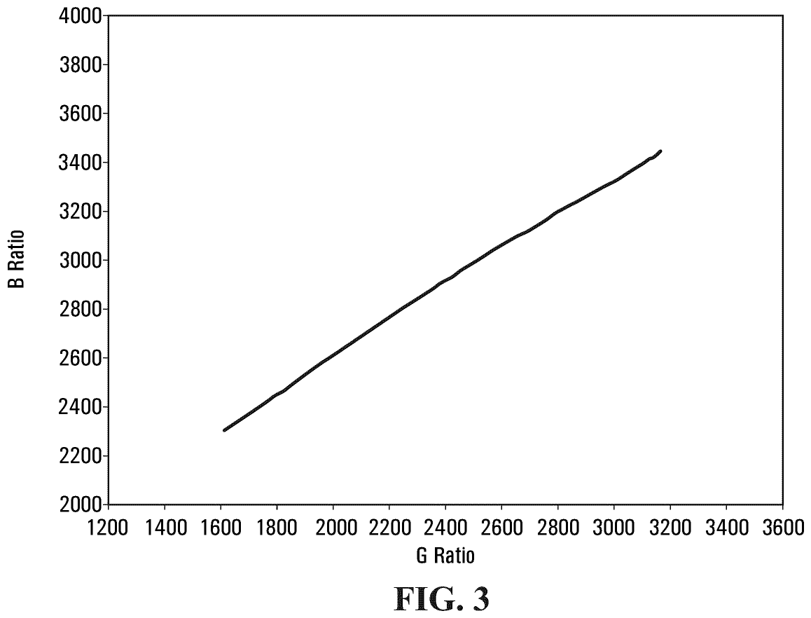

In some circumstances it is desirable to use the color readings to determine when the filter 106 has reached a desirable color or transmittance level and thus cease applying voltage, which may be done be open circuiting or short circuiting the electrodes together. In the past there have been attempts to use the color sensors to detect when the device has entered an undesirable color zone and cease applying power. However, in the embodiments herein fading of the filter 106 is stopped in a desirable color space. For example, FIG. 3 is a graph of the first wavelength ratio vs. a second wavelength ratio for the filter 106, in which the first wavelength is blue (approximately 465 nm) and the second wavelength is green (approximately 525 nm).

In FIG. 3 the vertical axis is the blue color reading behind the filter 106 divided by the blue color reading without the filter 106 (i.e., the blue color that is incident on the filter). The horizontal axis is similar except with blue replaced with green.

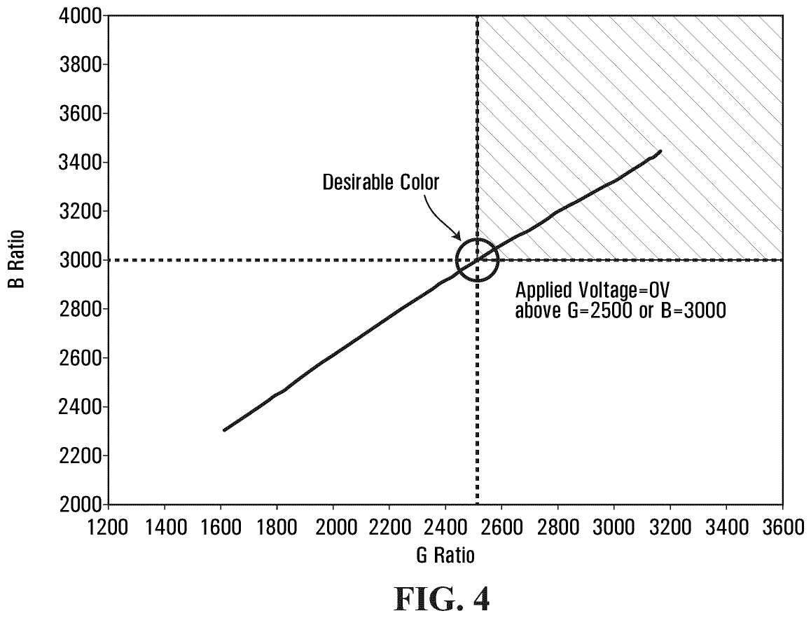

By just using the blue (B) and green (G) readings, a desirable 2D color space is defined. In FIG. 4 for example, a desirable color space occurring at B=3000, G=2500 for example. Unlike red-hangup that adjusts the voltage up when red is detected, a method to cease applying voltage upon detecting of the desirable color space comprises determining whether the initial indication of intensity is in the desirable color space, and ceasing applying voltage by open or short circuiting the filter 106 if so. In FIG. 4, the controller 108 ceases to apply voltage if either blue or green readings are above the desirable color space threshold values, as depicted by the shaded zone in FIG. 4.

### Current Voltage Compensation

In another embodiment, the controller 108 determines the current flowing through the optical filter 106, and the voltage applied across the filter 106 is adjusted in response to the current.

Instead of using temperature or color as a metric to determine when to adjust the voltage applied to the filter 106 during fading, in certain embodiments the controller 108 determines the required voltage directly by measuring current flowing through the filter 106. This determination uses a closed loop system since increasing the voltage applied increase the current, which increases the voltage droop, which increases the required applied voltage for fading. The controller 108 uses a lookup table to determine the voltage droop in the filter 106 from the measured current and the amount the applied voltage needs to be increased to in order to eliminate the droop. The controller 108 increases the applied voltage accordingly, which in turn increases droop. Consequently, the controller 108 iteratively repeats this method until the error between one or both of the droop and required applied voltage for fading for sequential iterations reduces to below a maximum error threshold, which represents equilibrium.

In the depicted embodiments the area of lowest applied voltage is the strip in the middle of the 106 furthest from each bus-bar. At equilibrium the voltage in the middle of the filter 106 is sufficient to fade the filter 106 to at least a minimum transmittance and no further voltage increase is required. This assumes that the voltage required to fade the filter 106 in the middle never changes for the life of the filter 106 and that the increase in required voltage is only due to the increased current that results in an increased voltage droop. In order words, this assumes if there was no voltage droop the voltage needed to fade the filter 106 is constant and only the current increases over the life of the filter 106.

In one embodiment a shunt resistor is placed in series with the voltage application circuitry. The voltage across the shunt resistor is read into the controller 108 using an analog-to-digital converter (“ADC”) within the controller 108.

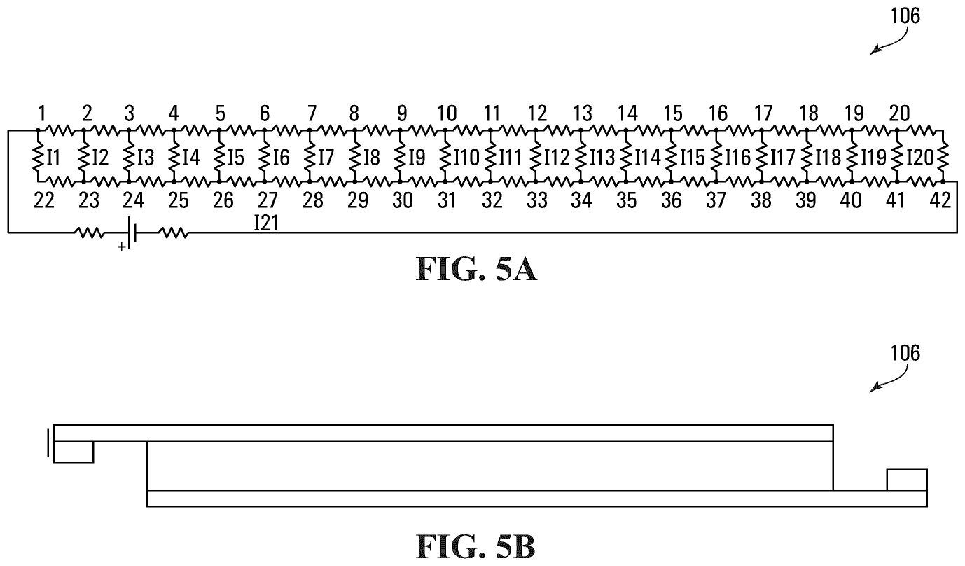

FIG. 5A is an electrical schematic of a model of the filter 106, and FIG. 5B is a sectional view of the filter 106 modeled in FIG. 5A, according to another embodiment that the controller 108 uses to model the threshold fading voltage required to eliminate voltage droop in the device 106.

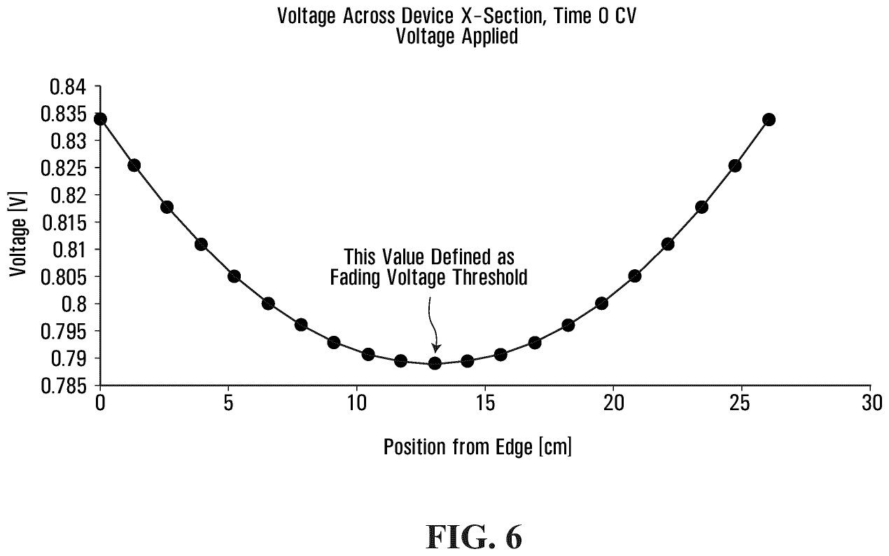

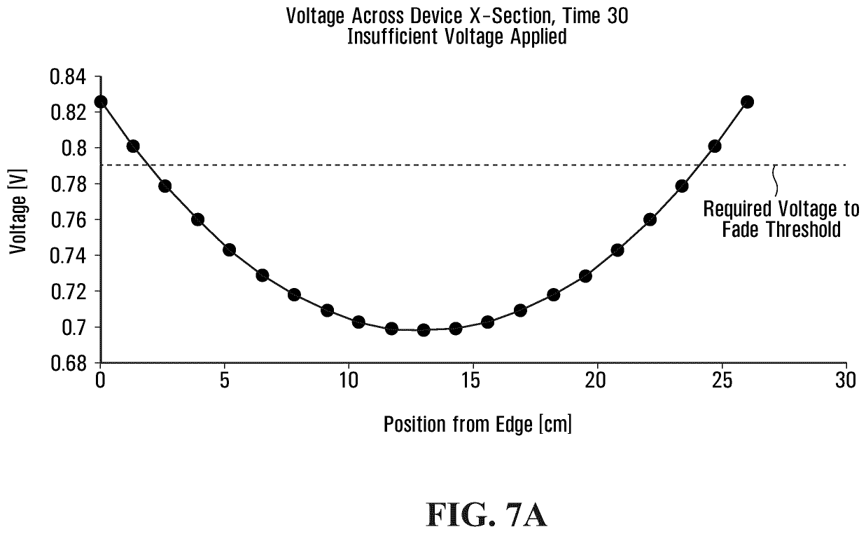

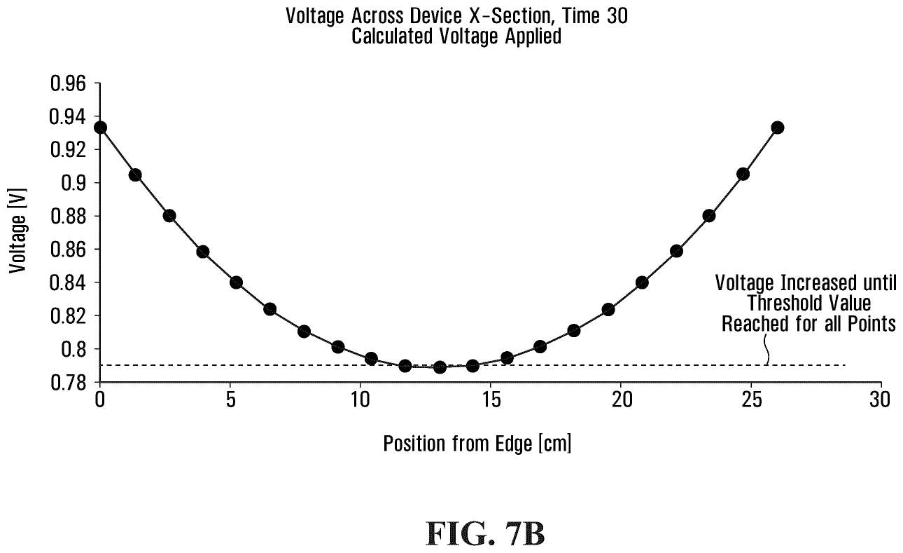

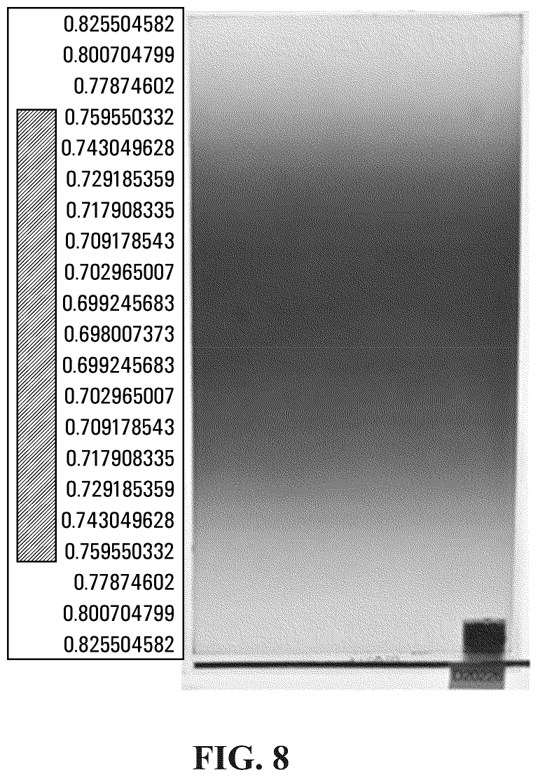

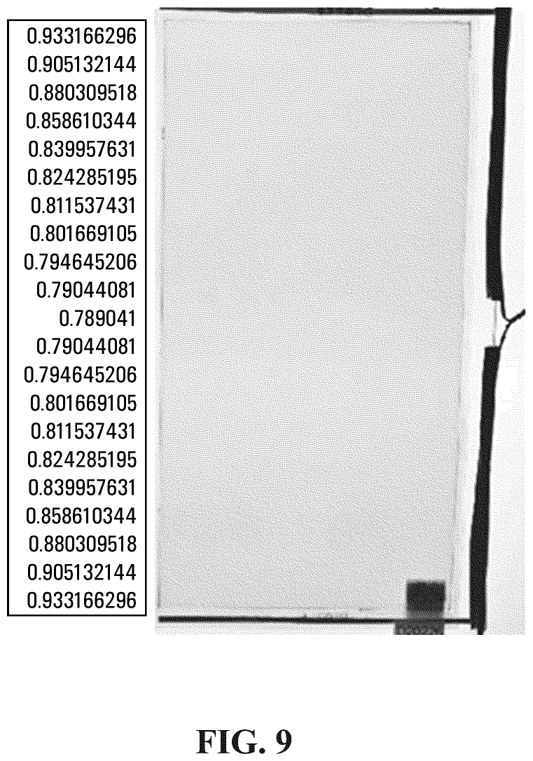

Using the model of FIG. 5A on filter D20226 shows that the threshold fading voltage for this device is 0.79 V, found at the center of the filter 106, which is the point furthest from both bus-bars. FIG. 6 shows the voltage across the filter 106 at time t=0 hours. At 30 hours of testing, the filter 106 draws 5.9 mA when an insufficient voltage (1.1 V) is applied; the insufficient fading resulting from applying 1.1 V is shown in FIG. 8. FIG. 7A shows the effect of voltage droop resulting from current flow at time t=30 hours. Using this information, applying the model of FIG. 5A results in a determination that a voltage of 1.24 V is required to properly fade the filter 106. The filter 106 was found experimentally to fully fade at 1.25 V; the sufficient fading resulting from applying 1.25 V is shown in FIG. 9 and FIG. 7B shows the voltage across the filter 106 when it is completely faded.

### Voltage Sensor Compensation

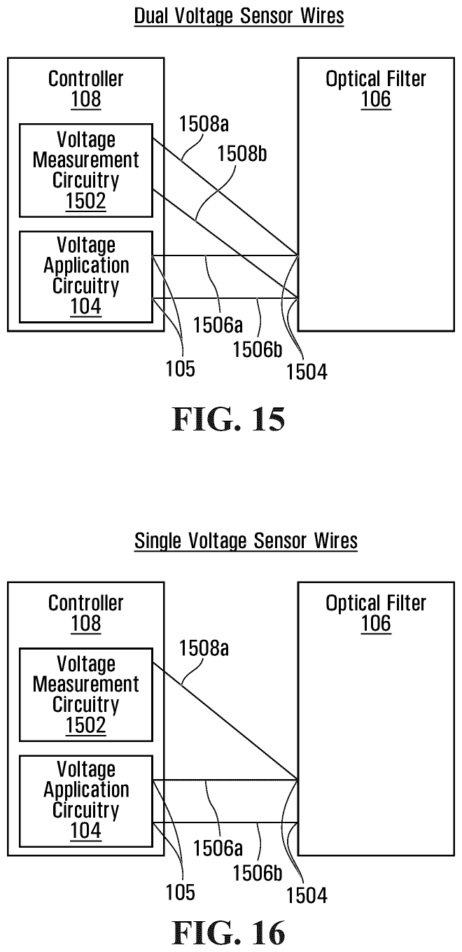

Referring now to FIGS. 15 and 16, there are depicted additional example embodiments in which the controller 108 determines the voltage actually applied across input terminals 1504 of the optical filter 106, as opposed to relying on voltage measured across the voltage application circuitry's 104 load terminals 105, to ensure that voltage drop is not preventing the desired voltage from reaching the optical filter 106. The controller 108 of each of the embodiments of FIGS. 15 and 16 comprises voltage measurement circuitry 1502, which may comprise a voltmeter or other type of voltage sensor, and the voltage application circuitry 104. One or more voltage sensing lines 1508a,b electrically couple the voltage measurement circuitry 1502 to at least one of the optical filter's 106 input terminals 1504. The input terminals 1504 are also electrically coupled to the voltage application circuitry's 104 load terminals 105 by first and second voltage application wires 1506a,b. While the controller 108 of FIGS. 15 and 16 comprises the voltage application circuitry 104 and voltage measurement circuitry 1502, in different example embodiments, one or both of the voltage application circuitry 104 and voltage measurement circuitry 1502 may be distinct from the controller 108. In at least some example embodiments, the controller 108 measures voltage relative to a common node that may or may not be electrically coupled to earth ground. For example, in the example embodiment described below, the controller 108 is battery powered and the common node is a negative terminal of the battery powering the controller 108. As used herein, the wires 1506a,b and 1508a,b are not limited to a particular size, shape, or material (e.g., tubular metal); rather, they refer to any suitable electrical conduction path.

During operation of the optical filter 106, the current flowing through the voltage application wires 1506a can result in resistive losses causing a voltage drop across the wires 1506a,b. This voltage drop can result in the voltage that is applied across the optical filter's 106 input terminals 1504 being insufficient to adequately fade the optical filter 106. For example, the wires 1506a,b may comprise a contact resistance portion resulting from the presence of a contact or a connector such that the voltage drop across that contact resistance portion may cause the voltage at the optical filter 106 to be insufficient for adequate fading. Additionally or alternatively, even if the wires 1506a,b have no contact resistance, by virtue of one or more of their length, composition, and shape the wires 1506a,b may have sufficient resistance that a material voltage drop occurs along them. By installing one or more remote voltage sense wires 1508a,b that electrically couple the optical filter's 106 input terminals 1504 to voltage measurement terminals at the controller 108, such as a controller ADC pin, the controller 108 can remotely sense the voltage that is actually applied across the optical filter 106. One or both of the remote voltage sense wires 1508a,b are in at least some example embodiments low resistance (e.g., less than 1Ω and terminated to high impendence (e.g., greater than 1 MΩ) terminals at the controller 108 to ensure minimal current flows through the wires 1508a,b during voltage measurement, thus helping to keep minimal voltage drop across the wires 1508a,b. In at least some example embodiments, using voltage sense wires 1508a,b as depicted in FIGS. 15 and 16 may be done when a significant voltage drop occurs along the voltage application wires 1506a,b (e.g., an overall drop of at least 20 mV for a current draw of at least 20 mA for a voltage as output by the voltage application circuitry 104). In at least some example embodiments, given the relationship between resistance and wire length, a significant voltage drop occurs when the wires 1506a,b exceed a certain length, such as 1 m. Additionally or alternatively, in at least some other example embodiments such as those in which the wires 1506a,b comprise a contact resistance portion, a significant voltage drop occurs across that portion. If the controller 108 senses that the voltage output by the controller 108 is higher than the voltage actually applied across the optical filter 106 by at least a voltage drop threshold, as measured using the voltage sense wires 1508a,b, the controller 108 can increase the output voltage such that the voltage received by the optical filter 106 equals or exceeds the desired output voltage.

In at least some example embodiments, two voltage sense wires 1508a,b can be used as depicted in FIG. 15. In such an example embodiment, the first sense wire 1508a is connected to a first voltage measurement terminal at the controller 108 (e.g., one controller ADC pin) and a first one of the input terminals 1504 (hereinafter simply “first input terminal 1504”) at the optical filter 106; the first input terminal 1504 is also connected by the first voltage application wire 1506a to a first one of the load terminals 105 (hereinafter simply “first load terminal 105”). Similarly, the second sense wire 108b is connected to a second voltage measurement terminal at the controller 108 (e.g., another controller ADC pin) and a second one of the input terminals 1504 (hereinafter simply “second input terminal 1504”) at the optical filter 106; the second input terminal 1504 is also connected by the second voltage application wire 1506b to a second one of the load terminals 105 (hereinafter simply “second load terminal 105”). In at least one example embodiment, the voltage output by the controller 108 as measured at and across the load terminals 105 is 2.0 V. Using the controller's 108 common node as a reference, the controller 108 measures the voltage at the first input terminal 1504 using the first voltage sensor wire 1508a; in this example, the controller 108 measures 1.95 V. Similarly, using the common node as a reference, the controller 108 measures the voltage at the second input terminal 1504 using the second voltage sensor wire 1508b; in this example, the controller 108 measures 0.05 V. From these measurements, the controller 108 determines the total voltage drop across the voltage application wires 1506a,b is 0.1 V and the controller 108 consequently adjusts the output voltage across the load terminals 105 to 2.1 V. This results in the voltage applied to the first input terminal 1504 to be measured as 2.05 V and the second input terminal 1504 to be measured as 0.05 V, resulting in a differential voltage across the optical filter 106 of 2.0 V. In at least some example embodiments the polarity of the voltage output by the controller 108 may then flip. After the polarity flip, the controller 108 again measures the voltage of the first voltage sensor wire 1508a relative to the common node, the voltage of the second voltage sensor wire 1508b relative to the common node, and may apply the same differential voltage calculation to determine whether the output voltage should be changed.

In at least some example embodiments, only a single voltage sensor wire 1508a,b may be used. For example, the first voltage sensor wire 1508a may be connected to the first load terminal 105 and the second voltage sensor wire 1508b may be missing, as depicted in FIG. 16. In at least one example, when the controller 108 is outputting a positive polarity the first input terminal 1504 is at 1.95 V relative to the common node and the second input terminal is at 0.05 V relative to the common node. The controller 108 is able to measure the voltage at the first input terminal 105 using the single voltage sense wire 1508a as 1.95 V using the first load terminal 105 as a reference. The controller 108 accordingly determines the voltage drop across the first wire 1506a as 0.05 V, and assumes that the same 0.05 V voltage drop occurs along the second wire 1506b connected to the second input terminal 1504. On the basis of this assumption, the controller 108 again adjusts the voltage it outputs to 2.1 V, resulting in the same 2.0 V voltage differential as in the previous example. Alternatively, and as in the previous example, if the polarity had been flipped the controller 108 uses the common node as a reference against which to measure the voltage of the only sensor wire 1508a, measures 0.05 V, and assumes the same 0.05 V voltage drop occurs in the second voltage application wire 1508b. The controller 108 may then again adjust the voltage it outputs to 2.1 V.

While in the above example embodiments the controller 108 uses the common node have a voltage of 0.0 V as a reference to measure the voltage on either of the sensing wires 1508a,b, in at least some other example embodiments the reference may be a positive voltage or a negative voltage, or be earth ground, depending on the particular embodiment. If the two voltage application wires 1506a,b are different lengths, performing a pair of voltage drop measurements by measuring the voltage of the first wire 1506a relative to a known reference and measuring the voltage of the second wire 1506b relative to a known reference accounts for that length difference and consequent difference in wire resistance. In at least some example embodiments, both voltage application wires 1506a,b have the same length in a single wire voltage sensor embodiment such as that shown in FIG. 16.

In another example embodiment, the voltage across the optical filter's 106 input terminals 1504 may be directly measured by, for example, a voltmeter electrically coupled directly across the terminals 1504. The voltage measured directly across the terminals 1504 may then be compared to the voltage output by the controller 108 at the load terminals 105. As in the example embodiments of FIGS. 15 and 16, the voltage as output at the load terminals 105 may then be increased as desired to compensate for any voltage drop across the wires 1506a,b.

Voltage Compensation Based on Combinations of Different Types of Sensor Readings

In some embodiments, readings from any two or more of current, temperature, voltage, and color sensors are used to determine what voltage to apply across the filter 106.

In one embodiment, one benefit of adopting this approach may be to provide a fail-safe in the event one sensor isn't working correctly. Using data from multiple sensors may also be useful to smooth out noisy sensor data or data outliers. For example, temperature may be used to estimate current or vice-versa if the filter 106 has a transfer function that relates the two quantities. By measuring both and taking the average, in certain embodiments the accuracy of the current or temperature reading may be improved.

Another example of using multiple sensors is to hold a device at 50% of its full transmission range. In one example embodiment, the color of the optical filter 106 at any particular percentage transmittance varies with temperature. For example, at 25° C. the blue ratio (“B”) of the filter 106 may be 3,000 and the green ratio (“G”) 2,500, whereas at 45° C. the blue ratio may be 3,100 and the green ratio 2,600. The controller 108 may use this information in combination with different types of sensor data to control filter transmittance.

For example, in one embodiment the color data along with at least one of the temperature data and the current reading are used. For a given temperature there is a particular B and G color reading that indicates 50% faded. As temperature rises the 50% fade point increases as the absolute dark and faded states also increase accordingly. By just using the temperature reading in combination with the color readings the controller 108 determines more accurately when to cease applying voltage to the filter 106 to hold the filter 106 at 50% transmittance. By measuring current as well, the controller 108 may in certain embodiments better detect the temperature of the filter 106. Alternatively a current reading may detect if the V-I relationship for a particular filter 106 has changed over time such that when voltage is applied it is adjusted to ensure complete fading of all chromophores (i.e., uniform fading across the filter 106). The temperature and color readings do not take into account the performance changes of a particular filter 106 while current is good at detecting this change. An example how multiple sensors aid in holding a device at 50% transmittance is described below. In all the examples below, the embodiments of one or both of FIGS. 15 and 16 may be applied to improve the accuracy of the voltage applied across the optical filter 106 by helping to ensure the voltage drop through the voltage application wires 1506a,b does not affect the control of the filter's 106 transmittance
1. Color sensor alone. When the indication of intensity as determined using color data shows that the filter 106 is outside of the desirable color space, the controller 108 applies a voltage of 1.0 V across the filter 106. When the indication of intensity shows the filter 106 is in the desirable color space, it applies 0.0 V. The desirable color space is defined by (B=3000, G=2500)
2. Color sensor+temperature. When the controller 108 has access to only temperature and color data, the controller 108 adjusts the desirable color space accordingly when the color of the optical filter 106 at any particular percentage transmittance varies with temperature. For example, in one such embodiment the controller 108 determines the filter 106 is at 45° C. and defines the desirable color space using (B=3100, G=2600) as opposed to (B=3000, G=2500), which is suitable for 25° C. When the filter 106 is outside the color space, the controller 108 also increases applied voltage to 1.2 V because of increased droop caused by the higher temperature. The controller 108 again applies 0.0 V when the filter 106 is in the desirable color space.
3. Color sensor+current. When the controller 108 has access to only current and color data, the controller 108 infers from the current flowing through the filter 106 that the filter's 106 temperature is well over 45° C. and accordingly defines the desirable color space using (B=3200, G=2700) and applies a voltage of 1.3 V when the filter 106 is outside this space. The controller 108 again applies 0.0 V when the filter 106 is in the desirable color space. However, in this example, the increased current draw results from the filter's 106 age as opposed to temperature.
4. Color sensor+temperature+current. When the controller 108 has access to all of temperature, current, and color data, it can properly define the desirable color space using (B=3100, G=2600) based on temperature and can apply the proper 1.3 V when the filter 106 is outside of this space based on current. The controller 108 again applies 0.0 V when the filter 106 is in the desirable color space.

### IR Filtering of Color Sensors

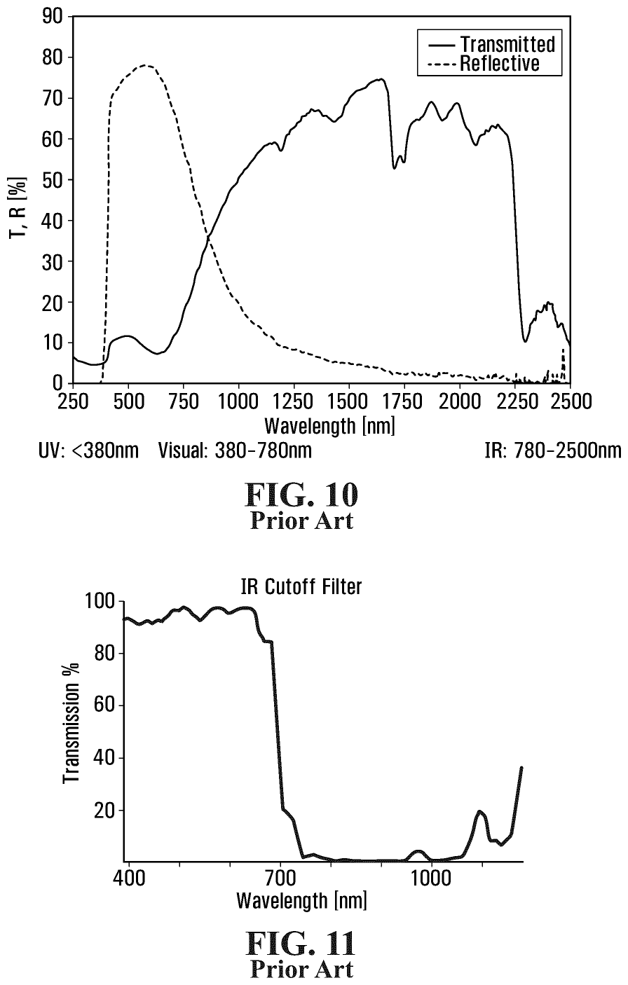

During testing of RGB color sensing devices for use as the light sensors 107 it was found that the reading was linear with light intensity while indoors using fluorescent films or solar simulator and neutral filters placed above the color sensing device or by moving the device further from the light source. However, when this same test was repeated outside using sunlight the readings were variable and unreliable. The reading versus light intensity was non-linear and often read 0 well before there was no light incident on the device. The reading also sometimes decreased with increasing light intensity when outdoors. It was determined that despite having IR filters built into the color sensing devices, these did not block enough IR light and IR light was affecting the linearity of the sensors. As a result tests were repeated with stacks of one XIR filter, two XIR filters, three XIR filters, and four XIR filters above the color sensing device. This was to try determine if blocking more IR light resulted in improvement in readings. While two XIR filters had slightly more linear readings compared with one XIR filter, the most significant gain was between no XIR filter and having one. There was no noticeable benefit between two and four XIR films. XIR films block far-IR light as shown in FIG. 10. As used herein, “near-IR” refers to infrared light in the range of approximately 700 nm and approximately 1,000 nm, and “far-IR” refers to infrared light greater than approximately 1,000 nm and, in certain embodiments, less than approximately 2,500 nm.

In order to improve the readings further, a glass IR cut-off filter from Edmunds Optics™ was ordered, which blocked off near-IR light above 700 nm, to replace the XIR film. A graph of transmittance vs. wavelength for this filter is shown in FIG. 11.

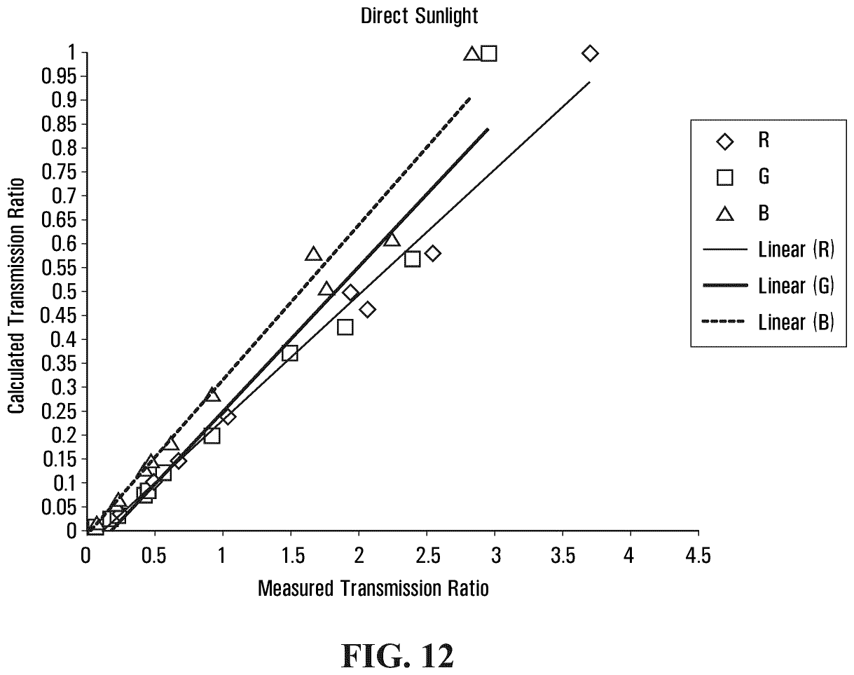

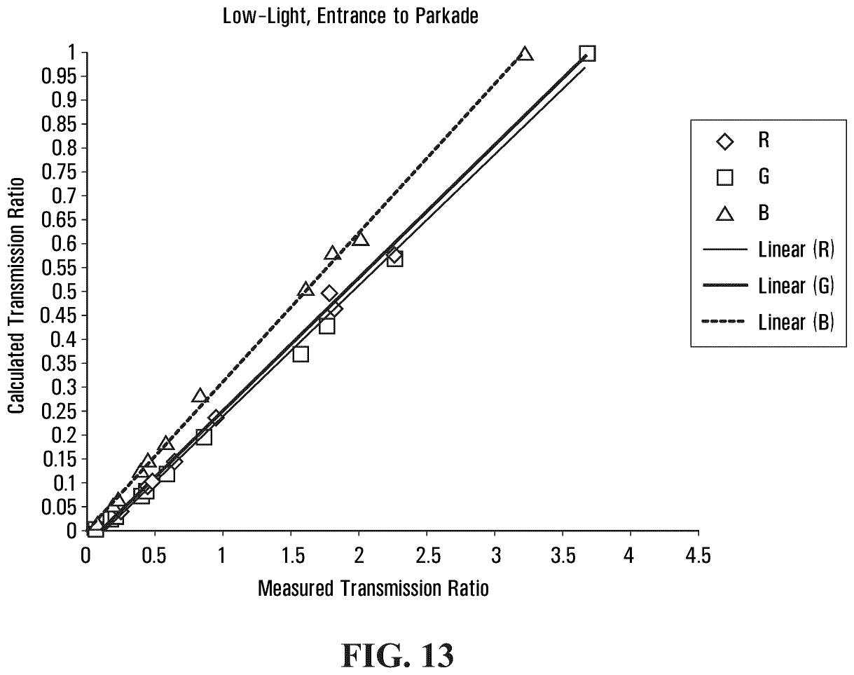

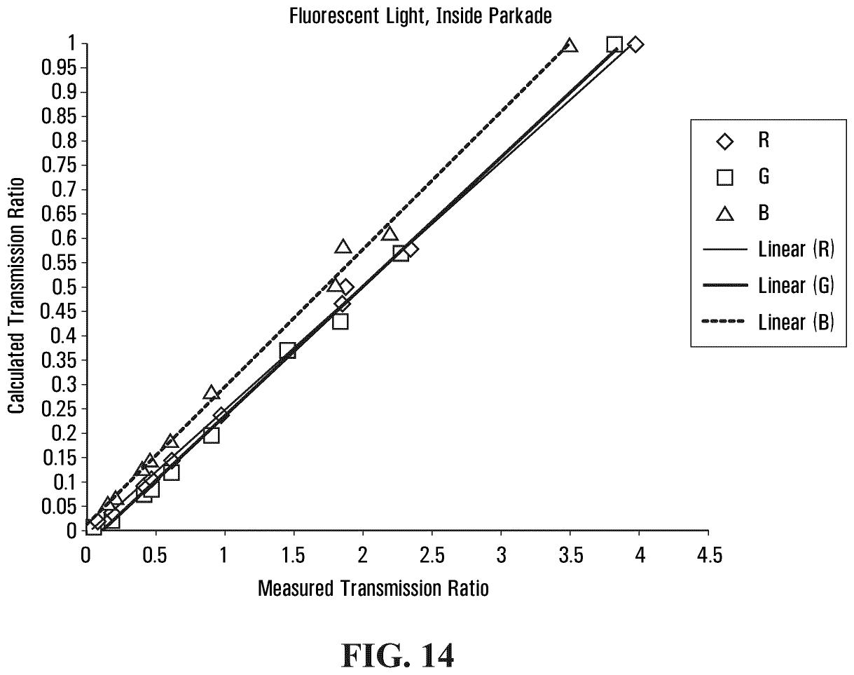

This filter, however, showed increasing transmission above 1100 nm and it was confirmed with the manufacturer that the transmission continued to increase past this wavelength. The final stack included one XIR film and one IR cut-off filter between the light and the color sensing device. This combination of blocking near and far-IR resulted in linear and repeatable readings from the color sensing devices in all lighting conditions compared with light intensity. FIGS. 12 to 14 are graphs showing calculated vs. measured transmission ratios of a red, green, and blue (“RGB”) color sensing device operating in various ambient conditions and comprising a pair of filters (one near-IR and one far-IR), according to another embodiment. The data in FIG. 12 was obtained in direct sunlight; the data in FIG. 13 was obtained in low-light at an entrance to a parkade; and the data in FIG. 14 was obtained in fluorescent light within that parkade. As FIGS. 12 to 14 show, with both near-IR and far-IR blocked the readings for each of red, green, and blue light are generally linear for various light types and intensities.

In FIGS. 12 to 14, the RGB color sensing device is an example of a color sensing device that comprises one near-IR filter and one far-IR filter. In different embodiments, the color sensing device may comprise one or more filters collectively filtering the near-IR and far-IR wavelengths. The filters are positioned such that light passes through them before being incident on the color sensor.

The embodiments have been described above with reference to flowcharts and block diagrams of methods, apparatuses, systems, and computer program products. In this regard, the block diagram of FIG. 1 illustrates the architecture, functionality, and operation of implementations of various embodiments. For instance, each block of the flowcharts and block diagrams may represent a module, segment, or portion of code, which comprises one or more executable instructions for implementing the specified action(s). In some alternative embodiments, the action(s) noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions. These computer program instructions may be provided to a processor of a computer, such as one particularly configured to anatomy generation or simulation, or other programmable data processing apparatus to produce a machine, such that the instructions, which execute via the processor of the computer or other programmable data processing apparatus, create means for implementing the actions specified in the blocks of the flowcharts and block diagrams.

These computer program instructions may also be stored in a computer readable medium that can direct a computer, other programmable data processing apparatus, or other devices to function in a particular manner, such that the instructions stored in the computer readable medium produce an article of manufacture including instructions that implement the actions specified in the blocks of the flowcharts and block diagrams. The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the actions specified in the blocks of the flowcharts and block diagrams.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. For example, references to measuring “a wavelength” herein comprise measuring multiple discrete wavelengths, one or more wavelength ranges, or an entire spectrum (e.g., when the color sensor is a photodiode).

It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

As used herein, being “approximately” a value means being within +/−10% of that value.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims.

One or more example embodiments have been described by way of illustration only. This description is been presented for purposes of illustration and description, but is not intended to be exhaustive or limited to the form disclosed. It will be apparent to persons skilled in the art that a number of variations and modifications can be made without departing from the scope of the claims.

1. A method for controlling a variable transmittance optical filter, the method comprising:
(a) determining at least one of a temperature of, color of, and current flowing through the optical filter, wherein transmittance of the optical filter decreases until reaching a minimum on exposure to a first stimulus and increases until reaching a maximum in response to application of a second stimulus, wherein at least one of the first and second stimuli comprises applying a voltage across the filter; and
(b) in response to at least one of the temperature, color, and current, adjusting the voltage applied across the filter.

2. The method of claim 1, wherein the temperature of the optical filter is determined, and the voltage applied across the filter is adjusted in response to the temperature.

3. The method of claim 2, wherein determining the temperature of the optical filter comprises:
(a) comparing the temperature to a shutdown temperature; and
(b) when the temperature equals or exceeds the shutdown temperature, short circuiting or open circuiting the filter.

4. The method of claim 2, wherein adjusting the voltage applied across the filter comprises:
(a) determining a magnitude of the voltage that corresponds to the temperature; and
(b) applying the voltage across the filter, wherein the magnitude of the voltage that is applied is the magnitude that corresponds to the temperature.

5. The method of claim 4, wherein the magnitude that corresponds to the temperature is a minimum magnitude required for the entirety of the filter to be at a threshold transmittance.

6. The method of claim 5, wherein the threshold transmittance is the maximum transmittance of the filter.

7. The method of any one of claims 4 to 6, wherein determining the magnitude of the voltage comprises referring to a one-to-one mapping of magnitudes and temperatures, wherein the magnitudes of the mapping increase monotonically between a first temperature of the mapping and a second temperature of the mapping that is higher than the first temperature.

8. The method of claim 7, wherein the first and second temperatures span at least 45° C.

9. The method of claim 8, wherein the first and second temperatures span from at least −40° C. to 125° C.

10. The method of any one of claims 7 to 9, wherein the magnitudes of the mapping decrease monotonically between a third temperature of the mapping and a fourth temperature of the mapping, wherein the fourth temperature is higher than the third temperature and less than the first temperature.

11. The method of claim 10, wherein the third temperature is less than 25° C.

12. The method of any one of claims 2 to 11, wherein the optical filter comprises a switching material attached to a non-opaque substrate, and wherein determining the temperature comprises:
(a) measuring a temperature of the substrate; and
(b) from the temperature of the substrate, determining the temperature of the optical filter as the temperature of the switching material.

13. The method of any one of claims 2 to 11, wherein the optical filter comprises a switching material located between two non-opaque substrates, and wherein determining the temperature comprises:
(a) measuring an ambient temperature of the optical filter;
(b) measuring intensity of a wavelength of light incident on the optical filter; and
(c) from the ambient temperature of and the intensity of light incident on the optical filter, determining the temperature of the optical filter as the temperature of the switching material.

14. The method of claim 1, wherein the color of the optical filter is determined, and the voltage applied across the filter is adjusted in response to the color.

15. The method of claim 14, wherein the color of the filter varies as the filter transitions between the light and dark states, and further comprising:
(a) determining an initial indication of intensity of a first wavelength of light transmitted through the filter, wherein adjusting the voltage applied across the filter adjusts the initial indication of intensity;
(b) comparing the initial indication of intensity to a first wavelength threshold; and
(c) adjusting the voltage applied across the filter in response to how the initial indication of intensity compares to the first wavelength threshold.

16. The method of claim 15, wherein the voltage applied across the filter is adjusted in response to whether the initial indication of intensity equals or exceeds the first wavelength threshold.

17. The method of claim 15 or 16, wherein the initial indication of intensity comprises a first wavelength ratio corresponding to a first time, and further comprising determining the first wavelength ratio by determining a ratio of intensity of the first wavelength of light incident on the filter at the first time relative to intensity of the first wavelength of light transmitted through the filter at the first time.

18. The method of any one of claims 15 to 17 wherein the first wavelength is red having a wavelength centered at approximately 615 nm.

19. The method of claim 17 or 18, further comprising determining a second wavelength ratio corresponding to the first time by determining a ratio of intensity of a second wavelength of light incident on the filter at the first time relative to intensity of the second wavelength of light transmitted through the filter at the first time, wherein the first and second wavelengths are different, and wherein the first wavelength ratio varies with the second wavelength ratio.

20. The method of claim 19, wherein the second wavelength is green having a wavelength centered at approximately 525 nm.

21. The method of claim 19 or 20, further comprising:
(a) determining a subsequent indication of intensity by:
(i) determining the first wavelength ratio corresponding to a second time by determining a ratio of intensity of the first wavelength of light incident on the filter at the second time relative to intensity of the first wavelength of light transmitted through the filter at the second time, wherein the second time is after the first time; and
(ii) determining the second wavelength ratio corresponding to the second time by determining a ratio of intensity of the second wavelength of light incident on the filter at the second time relative to intensity of the second wavelength of light transmitted through the filter at the second time;
(b) comparing the subsequent indication of intensity to the first wavelength threshold and to the initial indication of intensity; and
(c) adjusting the voltage applied across the filter in response to how the initial and subsequent indications of intensity compare to the first wavelength threshold and to each other.

22. The method of claim 21, wherein adjusting the voltage applied across the filter in response to how the initial and subsequent indications of intensity compare to the first wavelength threshold and to each other comprises, when the initial and subsequent indications of intensity are less than the first wavelength threshold by an error threshold and the subsequent indication of intensity is less than the initial indication of intensity, decreasing the voltage applied across the filter by a first voltage step.

23. The method of claim 21 or 22, wherein adjusting the voltage applied across the filter in response to how the initial and subsequent indications of intensity compare to the first wavelength threshold and to each other comprises, when the initial and subsequent indications of intensity are less than the first wavelength threshold by an error threshold and equal to each other, decreasing the voltage applied across the filter by a second voltage step that is less than the first voltage step.

24. The method of any one of claims 21 to 23, wherein adjusting the voltage applied across the filter in response to how the initial and subsequent indications of intensity compare to the first wavelength threshold and to each other comprises, when the initial and subsequent indications of intensity are less than the first wavelength threshold by an error threshold and the subsequent indication of intensity is greater than the initial indication of intensity, increasing the voltage applied across the filter by the second voltage step.

25. The method of any one of claims 21 to 24, wherein adjusting the voltage applied across the filter in response to how the initial and subsequent indications of intensity compare to the first wavelength threshold and to each other comprises, when the initial and subsequent indications of intensity are greater than the first wavelength threshold by an error threshold and equal to each other, increasing the voltage applied across the filter by the second voltage step.

26. The method of any one of claims 21 to 25, wherein adjusting the voltage applied across the filter in response to how the initial and subsequent indications of intensity compare to the first wavelength threshold and to each other comprises, when the initial and subsequent indications of intensity are greater than the first wavelength threshold by an error threshold and the subsequent indication of intensity is greater than the initial indication of intensity, increasing the voltage applied across the filter by the first voltage step.

27. The method of any one of claims 21 to 26, wherein adjusting the voltage applied across the filter in response to how the initial and subsequent indications of intensity compare to the first wavelength threshold and to each other comprises, when the initial indication of intensity is greater than the first wavelength threshold and the subsequent indication of intensity is less than the first wavelength threshold by an error threshold and less than the initial indication of intensity, decreasing the voltage applied across the filter by the second voltage step.

28. The method of claim 15 or 16, wherein adjusting the voltage across the filter comprises short circuiting or open circuiting the filter.

29. The method of claim 15, wherein the initial indication of intensity comprises a first and a second wavelength ratio each corresponding to a first time, and further comprising:
(a) determining the first wavelength ratio by determining a ratio of intensity of the first wavelength of light incident on the filter at the first time relative to intensity of the first wavelength of light transmitted through the filter at the first time; and
(b) determining the second wavelength ratio by determining a ratio of intensity of a second wavelength of light incident on the filter at the first time relative to intensity of the second wavelength of light transmitted through the filter at the first time, wherein the first and second wavelengths are different, wherein the first wavelength threshold and a second wavelength threshold define a desirable color space,
wherein comparing the initial indication of intensity to the first wavelength threshold comprises determining whether the initial indication of intensity is in the desirable color space, and
wherein adjusting the voltage across the filter comprises short circuiting or open circuiting the filter when the initial indication of intensity is in the desirable color space.

30. The method of claim 29, wherein the first wavelength is blue, having a wavelength centered at approximately 465 nm, and the second wavelength is green, having a wavelength centered at approximately 525 nm.

31. The method of any one of claims 14 to 29, wherein determining the color of the optical filter comprises using a color sensing device, the sensing device comprising:
(a) a color sensor; and
(b) one or more filters collectively filtering near-infrared and far-infrared wavelengths, wherein the one or more filters are positioned such that light incident on the color sensor passes through the one or more filters before being incident on the color sensor and wherein the near-infrared wavelengths are between approximately 700 nm and 1,000 nm and the far-infrared wavelengths are above approximately 1,000 nm.

32. The method of claim 31, wherein the one or more filters comprise a near-infrared filter and a far-infrared filter.

33. The method of claim 1, wherein the current flowing through the optical filter is determined, and the voltage applied across the filter is adjusted in response to the current.

34. The method of claim 33, further comprising:
(a) determining, from the current flowing through the filter, a voltage magnitude sufficient to cause an entirety of the optical filter to exceed a minimum transmittance; and
(b) applying the voltage having the voltage magnitude across the filter.

35. The method of claim 33, further comprising increasing the voltage applied across the filter to a minimum voltage required to cause an entirety of the filter to exceed a minimum transmittance by iteratively:
(a) determining, from the current flowing through the filter, the minimum voltage required to cause an entirety of the filter to exceed the minimum transmittance;
(b) comparing the voltage applied across the filter to the minimum voltage; and
(c) when the voltage applied across the filter is less than the minimum voltage, increasing the voltage to at least the minimum voltage.

36. The method of claim 33 or 34, wherein the minimum transmittance is within 10% of the transmittance of the optical filter in the light state.

37. The method of claim 36, wherein the minimum transmittance is the transmittance of the optical filter in the light state.

38. The method of claim 1, wherein at least two of the temperature of, color of, and current flowing through the optical filter are determined, and the voltage applied across the filter is adjusted in response to the at least two of the temperature of, color of, and current flowing through the optical filter that are determined.

39. The method of claim 38, wherein all of the temperature of, color of, and current flowing through the optical filter are determined, and the voltage applied across the filter is adjusted in response to all of the temperature of, color of, and current flowing through the optical filter that are determined.

40. The method of claim 39, wherein the current is used to determine the voltage applied across the filter and the temperature is used to define a desirable color space.

41. The method of any one of claims 1 to 40, wherein the first stimulus comprises incident visible light and the second stimulus comprises applying the voltage.

42. The method of any one of claims 1 to 41, wherein the filter comprises:
(a) a non-opaque substrate;
(b) a switching material affixed to the substrate and positioned such that at least some light that passes through the substrate also passes through the switching material; and
(c) a first electrode and a second electrode electrically coupled to the switching material, wherein the voltage is applied across the first and second electrodes.

43. The method of claim 42, wherein each of the first and second electrodes is a planar electrode, and wherein the filter further comprises a first and a second bus bar respectively electrically coupled to the first and the second electrode, wherein the first and the second bus bar are positioned such that all current paths between the bus bars have identical path lengths.

44. A variable transmittance optical filter assembly, the assembly comprising:
(a) a non-opaque substrate;
(b) a switching material affixed to the substrate and positioned such that at least some light that passes through the substrate also passes through the switching material;
(c) a first electrode and a second electrode electrically coupled to the switching material, wherein transmittance of the switching material decreases until reaching a minimum on exposure to a first stimulus and increases until reaching a maximum in response to application of a second stimulus, wherein at least one of the first and second stimuli comprises applying a voltage across the electrodes;
(d) voltage application circuitry for selectively applying different voltages across the electrodes;
(e) at least one of:
(i) a color sensing device positioned to measure a color of light that has passed through the optical filter;
(ii) a temperature sensor positioned to measure a temperature of the optical filter or an ambient temperature around the optical filter; and
(iii) a current sensor electrically coupled to the voltage application circuitry;
(f) a computer readable medium and a processor communicatively coupled to the computer readable medium, the voltage application circuitry, and the at least one of the color sensor, temperature sensor, and current sensor, wherein the computer readable medium has encoded thereon computer program code, executable by the processor, which when executed by the processor causes the processor to perform the method of any one of claims 1 to 43.

45. The filter assembly of claim 44, wherein the electrodes are planar and the switching material is between the electrodes.

46. The filter assembly of claim 45, further comprising a bus-bar electrically coupled to and extending along each of the electrodes.

47. The filter assembly of claim 46, wherein the bus-bars extend along opposing edge portions of the electrodes.

48. The filter assembly of any one of claims 44 to 47, comprising the color sensing device.

49. The filter assembly of claim 48, wherein the color sensing device comprises:
(a) a color sensor; and
(b) one or more filters collectively filtering near-infrared and far-infrared wavelengths, wherein the one or more filters are positioned such that light incident on the color sensor passes through the one or more filters before being incident on the color sensor and wherein the near-infrared wavelengths are between approximately 700 nm and 1,000 nm and the far-infrared wavelengths are above approximately 1,000 nm.

50. The method of claim 49, wherein the one or more filters comprise a near-infrared filter and a far-infrared filter.

51. The filter assembly of any one of claims 44 to 50, comprising the temperature sensor.

52. The filter assembly of any one of claims 44 to 51, comprising the current sensor.

53. A non-transitory computer readable medium having encoded thereon computer program code, executable by a processor, which when executed by the processor causes the processor to perform the method of any one of claims 1 to 43.
